(19) United States
(12) Patent Application Publication
(10) Pub. No.: US 2010/0199726 A1
(43) Pub. Date: Aug. 12, 2010

(54) WINDOW LOCK

(75) Inventors: Jim R. Varney, Maynard, MA (US); Bryan R. Hotaling, Harvard, MA (US); Jim Ormond, Watertown, MA (US); Scott A. Leclerc, Ashby, MA (US)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 12/703,005

(22) Filed: Feb. 9, 2010

Related U.S. Application Data
(60) Provisional application No. 61/152,118, filed on Feb. 12, 2009.

(51) Int. Cl. E05B 65/08; E05C 3/12

(52) U.S. Cl. 70/90; 292/216

(57) ABSTRACT

A window lock includes a stationary support base adapted to mount to a window frame. The window lock also includes a window-movement blocker mounted on the stationary support base to block selectively movement of a window panel relative to the stationary support base at the option of a user.

This application claims priority under 35 U.S.C. §119(e) to U.S. Provisional Application Ser. No. 61/152,118, filed Feb. 12, 2009, which is expressly incorporated by reference herein.

### BACKGROUND

The present disclosure relates to locks, and particularly to locks for windows. More particularly, the present disclosure relates to locks for windows that mount on a window frame.

### SUMMARY

A window lock in accordance with the present disclosure includes a stationary support base adapted for mounting on a window frame and a window-movement blocker mounted on the stationary support base to limit up-and-down movement of a window panel carried in the window frame. The window-movement blocker is configured to rotate about an arm-rotation axis between a window-locking position wherein up-and-down movement of the window panel is limited and a window-unlocking position wherein up-and-down movement of the window panel is freed.

In illustrative embodiments, the window lock further includes a blocker-movement controller configured to allow a user to control movement of the window-movement blocker. The window-movement controller includes a barrier lock coupled to the stationary support base for normally blocking movement of the window-movement blocker relative to stationary support base in a locking position. The blocker-movement controller also include a barrier-lock actuator configured to provide means for moving the barrier lock out of engagement with the window-movement blocker to free the window-movement blocker to rotate about arm-rotation axis between the window-locking position and the window-unlocking position.

In illustrative embodiments, the barrier lock includes an anchor arranged to extend toward the window-movement blocker to engage the window-movement blocker and an anchor mover configured to apply a biasing force to the anchor to urge the anchor into the locking position. In illustrative embodiments, the user moves the anchor by engaging a lock mover included in the barrier-lock actuator. The lock mover is coupled to the anchor and arranged to extend through an actuation slot formed in a front wall of the stationary support base.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIGS. 1-3 are a series of perspective views showing a window lock in accordance with the present disclosure being used to limit up-and-down movement of a lower window panel included in the window;

FIG. 1 is a perspective view of a window lock showing the window lock mounted on a window frame and arranged in an un-deployed state in which a window-movement blacker included in the window lock is arranged in a window-locking position that permits free up-and-down movement of the lower window panel;

FIG. 2 is a perspective view of the window lock of FIG. 1 showing the window lock in a deployed state in which the window-movement blocker has rotated about an arm-rotation axis in a clockwise direction toward the window to assume a window-locking position that limits up-and-down movement of the lower window panel between a closed position and a partly-opened position as suggested in FIG. 3;

FIG. 3 is a perspective view of the window lock of FIGS. 1 and 2 showing the window lock in the deployed position and showing that the lower window panel has moved to the partly-opened position and further upward movement of the lower window panel is blocked by the window-movement blocker;

FIG. 4 is an exploded perspective view of the window lock of FIGS. 1-3, showing that the window lock includes, from left to right, a window-movement blocker including a barrier arm formed to include an anchor receiver and an arm-rotation axle, a blocker-mover spring configured to bias the barrier arm into the window-locking position, a blocker carrier, a position guide appended to the blocker carrier and formed to include a triangular shaped anchor slot, a triangular shaped anchor, a lock mover appended to the anchor, an anchor-extension spring configured to bias the anchor into the locked position, a carrier foundation formed to include an actuation slot, and a stationary foundation fastener adapted to mount the window lock to a window frame;

FIGS. 5-8 show an illustrative series of steps performed by a user to move the lock from the un-deployed state shown in FIG. 1 to the deployed state shown in FIG. 3 (FIGS. 5-7) and back to the un-deployed state (FIG. 8);

FIG. 5 is an end elevation view of the window lock of FIG. 1, with portions broken away, showing that the barrier arm included in the window-movement blocker is retained in the window-unlocking position by the anchor which is arranged to lie in the locked position, in which the anchor extends into the anchor receiver formed in the barrier arm to block movement of the barrier relative to the anchor;

FIG. 6 is a view similar to FIG. 5 showing that a user's thumb has applied a button-actuation force to the lock mover to cause the anchor to move from the locked position to the unlocked position in which the anchor has withdrawn from the anchor receiver to cause the barrier arm to rotate to the window-locking position so that up-and-down movement of the lower window panel is restricted as shown in FIG. 3;

FIG. 7 is a view similar to FIG. 6 suggesting that the user's thumb has disengaged the lock mover and that the anchor has returned to the normally locked position to cause movement of the barrier arm relative to the anchor to be blocked;

FIG. 8 is a view similar to FIG. 7 showing that the user's thumb has re-applied the button-actuation force to the lock mover to cause the anchor to move to the unlocked position to free the barrier arm for movement relative to the anchor and suggesting that a user's finger then applies a barrier-rotation force (solid arrow) to the barrier arm to cause the barrier arm to rotate about the arm-rotation axis in a counter-clockwise direction (solid double arrow) relative to the anchor to cause the barrier arm to assume the window-unlocking position as shown in FIG. 1;

FIG. 9 is a front elevation view of the window lock of FIG. 1 showing that the barrier arm is in the window-unblocking position, that the lock mover is in the locked position, and that the un-deployed state of the window lock is communicated visually to a user by a visible unlocked-status icon visible on the barrier arm;

FIG. 10 is a sectional view taken along line 10-10 of FIG. 5 showing that the anchor is biased into engagement with the barrier arm by an anchor-extension spring and that a locked-status icon placed on the anchor is hidden by the barrier arm when the anchor is in the locked position and the barrier arm is in the window-unlocking position;

FIG. 11 is a sectional view taken along line 11-11 of FIG. 6 showing that the lock mover has been moved to the right by the button-actuation force (double solid arrow) supplied by the user's thumb and showing that the anchor has withdrawn from anchor receiver formed in the barrier arm so that the barrier arm is free to move as suggested in FIG. 12; and

FIG. 12 is a front elevation view of the window lock of FIG. 11 showing that the barrier arm is in the window-locking position, that the lock mover is in the locked position, and that the deployed state of the window lock is communicated visually to a user by the now visible locked-status icon placed on the anchor.

### DETAILED DESCRIPTION

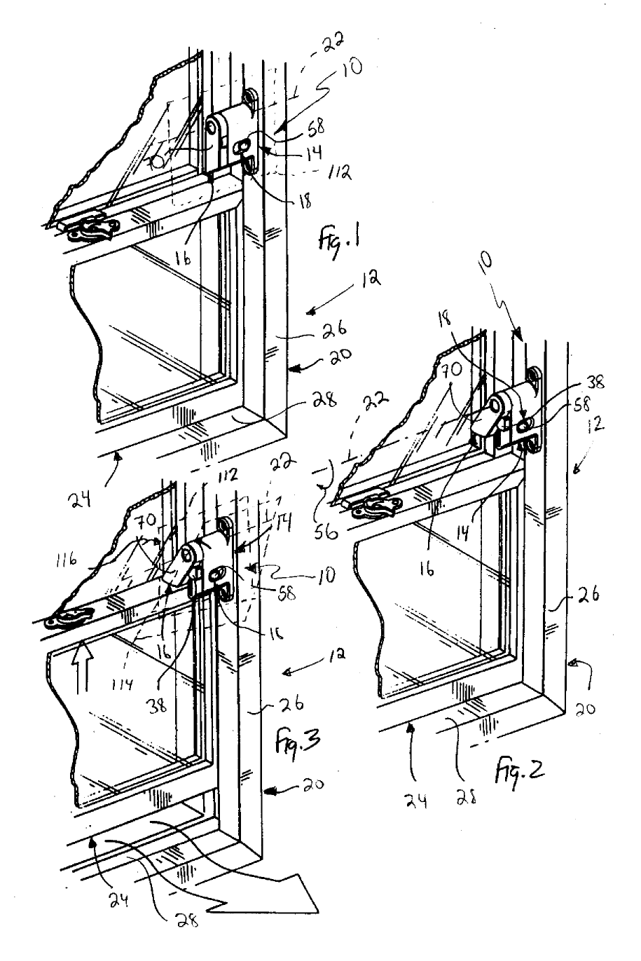

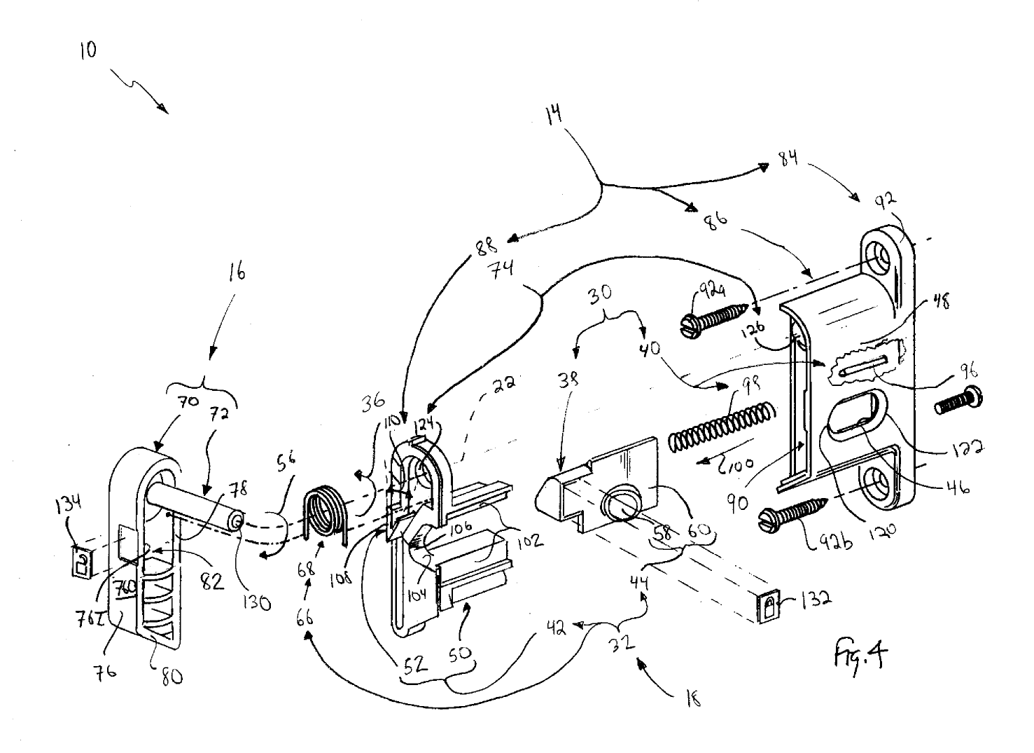

A lock 10 in accordance with the present disclosure is used to block up-and-down movement of a lower panel 24 as suggested in FIGS. 1-3. Illustratively, lower panel 24 is a lower window panel carried in a window frame 26. As shown in FIG. 4, lock 10 includes a blocker-support base 14 adapted for coupling to window frame 26 in a fixed position, a window-movement blocker 16 movable between a window-unlocking position (FIG. 1) wherein substantial up-and-down movement of lower panel 24 relative to window frame 26 is permitted and a window-locking position (FIGS. 2 and 3) wherein up-and-down movement of lower panel 24 relative to window frame 26 is blocked or limited.

Movement of window-movement blocker 16 between the window-locking position and the window-unlocking position is controlled by a blocker-movement controller 18 also included in lock 10. Blocker-movement controller 18 illustratively includes a barrier lock 30 and a barrier-lock actuator 32. Barrier-lock actuator 32 is coupled to barrier lock 30 to move barrier lock 30 between a locked position wherein movement of the window-movement blocker 16 is retained in its position and an unlocked position wherein the window-movement blocker 16 is free to move relative to blocker-support base 14.

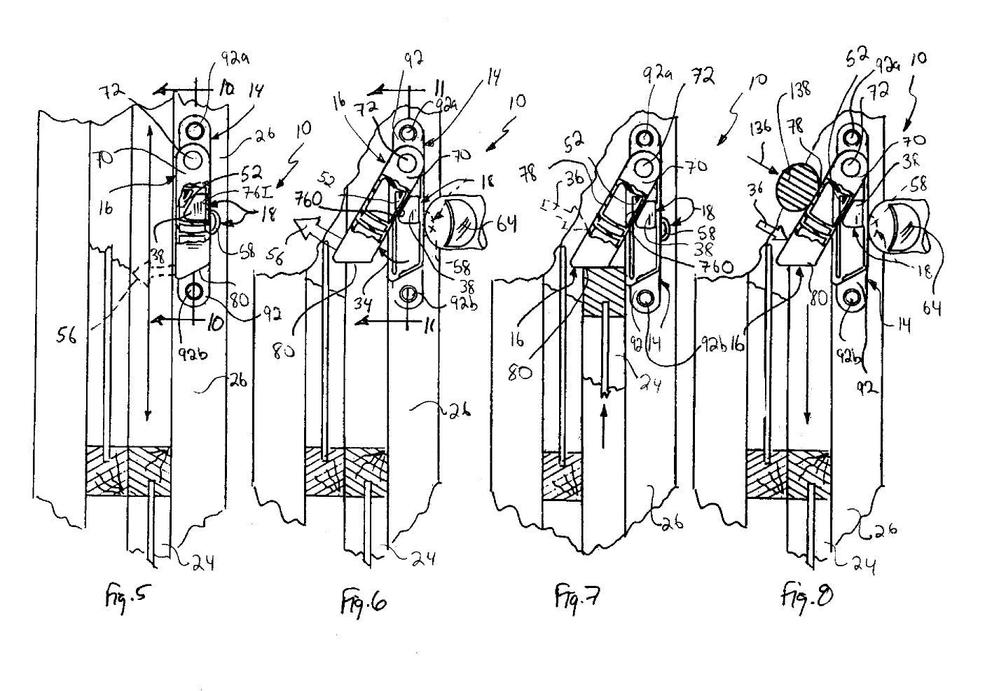

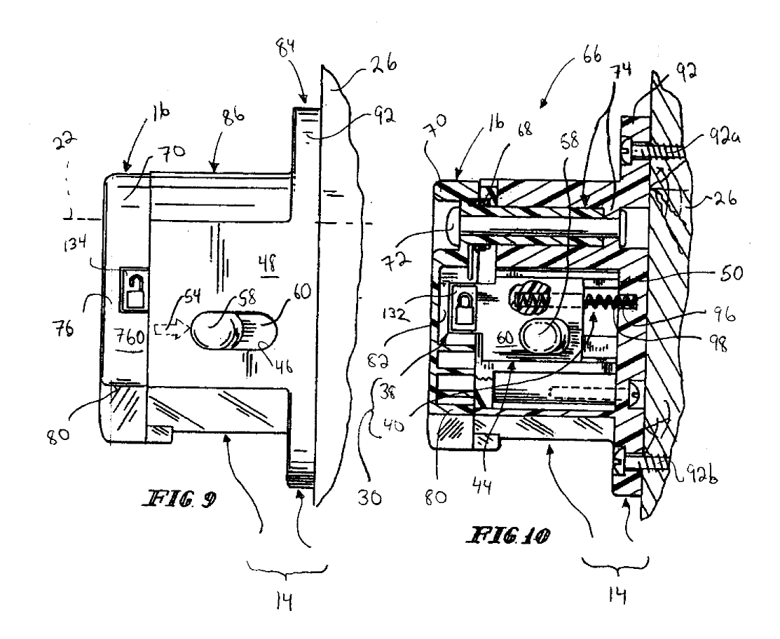

An illustrative process for using lock 10 comprises a series of steps as suggested in FIGS. 5-8. Deployment of lock 10 is shown illustratively in FIGS. 5-7 in which lock 10 goes from an un-deployed state (FIG. 5) to a deployed stated (FIG. 7). Retraction of lock 10 is suggested in FIGS. 7 and 8 wherein lock 10 is moved from the deployed state (FIG. 7) through a series of actions as suggested in FIG. 8.

As shown in FIG. 5, lock 10 begins in the un-deployed state wherein window-movement blacker 16 is in the window-unlocking position and barrier lock 30 is in the locked position. When lock 10 is in the un-deployed state, lower panel 24 is free to move up-and-down as suggested in FIG. 5. A user (not shown) deploys lock 10, as suggested in FIG. 5, by applying a button-actuation force 62 with a user's thumb 64 to barrier-lock actuator 32 to cause barrier lock 30 to move from the locking position to the unlocking position so that window-movement blocker 16 is free to move relative to blocker-support base 14. Illustratively, a biasing torque 34 biases window-movement blocker 16 into the window-locking position as shown in FIG. 6. After the user (not shown) removes user's thumb 64 from barrier-lock actuator 32, a biasing force 94 biases barrier lock 30 into the locking position to cause lock 10 to assume a deployed state as shown in FIG. 7. When lock 10 is in the deployed state, up-and-down movement of lower panel 24 is blocked or restricted.

As shown in FIG. 7, lock 10 is in the deployed state wherein window-movement blocker 16 is in the window-locking position and barrier lock 30 is in the locked position. A user (not shown) moves lock 10 to the un-deployed state in an illustrative series of steps. First, user (not shown) applies button-actuation force 62 with user's thumb 64 to move barrier lock 30 from the locked position to the unlocked position. Second, user (not shown) applies a barrier-rotation force 136 using user's finger 138 in counter-clockwise direction 36 to barrier arm 70 to cause barrier arm 70 to rotate in counter-clockwise direction 36 about arm-rotation axis 22 from the window-locking position to the window-unlocking position.

Lock 10, as suggested in FIGS. 1-3, is used to block substantial movement of a lower panel 24 included in window 12. Lock 10 illustratively includes blocker-support base 14, window-movement blocker 16, and blocker-movement controller 18 as shown in FIG. 4. Blocker-support base 14, as illustrated in FIGS. 1-3, is adapted to mount to window frame 26 included in window 12 in a fixed position. Window-movement blocker 16 is mounted on blocker-support base 14 to move between the window-unlocking position, as shown for example in FIG. 1, and the window-locking position as shown for example in FIGS. 2 and 3. As illustrated in FIG. 4, blocker-movement controller 18 is coupled to blocker-support base 14 and configured to block selectively movement of window-movement blocker 16 between the window-locking position and the window-unlocking position.

As suggested in FIG. 4, window-movement blocker 16 is mounted on blocker-support base 14 to move about an arm-rotation axis 22 between the window-locking position and the window-unlocking position. When window-movement blocker 16 is in the window-locking position, as shown in FIGS. 2 and 3, window-movement blocker 16 is adapted to block movement of lower panel 24 carried in window frame 26 of window 12 to keep lower panel 24 in mating contact with a sill 28 included in window frame 26. When window-movement blocker 16 is in the window unlocking-position, as shown in FIG. 1, window-movement blocker 16 is adapted to allow up-and-down movement of lower panel 24 relative to sill 28 included in window frame 26.

Blocker-movement controller 18 illustratively includes barrier lock 30 and barrier-lock actuator 32 configured to provide means for moving barrier lock 30 in a first stage of movement from a locked position, as shown in FIGS. 2 and 3, to an unlocked position as shown in FIG. 1. When barrier lock 30 is in the locked position, barrier lock 30 is arranged to engage window-movement blocker 16 to cause movement of window-movement blacker 16 relative to blocker-support base 14 to be restricted. When barrier lock 30 is in the unlocked position, barrier lock 30 is positioned to lie in spaced-apart relation to window-movement blocker 16 to free window-movement blacker 16 to move relative to blocker-support base 14 in a second stage of movement. During the second stage of movement, window-movement blocker 16 moves in response to a biasing torque 34 applied in a counter-clockwise direction 36 about arm-rotation axis 22 to window-movement blocker 16.

As shown in FIG. 4, barrier lock 30 includes an anchor 38 and an anchor mover 40. Anchor mover 40 is coupled to blocker-support base 14 and configured to provide biasing force 94 to anchor 38 to urge anchor 38 to assume the locked position as suggested in FIGS. 5 and 7.

Barrier-lock actuator 32 includes a position guide 42 and a lock mover 44. Position guide 42 is coupled to blocker-support base 14 in a fixed position. Lock mover 44 is coupled to anchor 38 to move therewith. Lock mover 44 is arranged illustratively to extend away from blocker-support base 14 through an actuation slot 46 formed in a front wall 48 of blocker-support base 14 as shown in FIGS. 4, 9, and 12.

As suggested in FIGS. 9-12, position guide 42 operates to support barrier lock 30 and barrier-lock actuator 32 during movement of barrier lock 30 between the locked and unlocked positions. Position guide 42 illustratively includes a lock support 50 and a blocker-rotation support 52. Lock support 50 is coupled to blocker-support base 14 and arranged to extend away from window-movement blocker 16 in an actuation direction 54. Actuation direction 54 is oriented away from window-movement blocker 16 and parallel to arm-rotation axis 22.

Blocker-rotation support 52 is coupled to blocker-support base 14 and arranged to extend away from blocker-support base 14 toward window-movement blocker 16. As shown in FIGS. 5-8, blocker-rotation support 52 is arranged to engage window-movement blocker 16 to limit rotation of window-movement blocker 16 about arm-rotation axis 22 in a clockwise direction 56 to cause window-movement blocker 16 to assume the window-locking position as shown in FIGS. 2, 3, and 7. Blocker-rotation support 52 is further arranged to limit rotation of window-movement blocker 16 about arm-rotation axis 22 in counter-clockwise direction 36 to cause window-movement blocker to assume the window-unlocking position as shown in FIGS. 1 and 5.

As suggested in FIG. 4, lock mover 44 of barrier-lock actuator 32 is used to transfer button-actuation force 62 from user's thumb 64 to barrier lock 30 to cause barrier lock 30 to move from the locked position to the unlocked position. Illustratively, lock mover 44 includes a lock-mover button 58 and a button-support plate 60. Button-support plate 60 is arranged to lie between front wall 48 of blocker-support base 14 and lock support 50 of position guide 42. Lock-mover button 58 is coupled to button-support plate 60 to cause button-support plate 60 to move from the locked position to the unlocked position in response to application of button-actuation force 62 applied in actuation direction 54. As shown in FIGS. 9 and 12, lock-mover button 58 is arranged to extend away from button-support plate 60 through actuation slot 46. Button-actuation force 62 is supplied by a user's thumb 64 as suggested in FIGS. 6 and 8.

Movement of window-movement blocker 16 to the window-locking position is aided by a blocker mover 66 also included blocker-movement controller 18, as suggested in FIG. 4. Blocker mover 66 is configured to provide means for providing biasing torque 34 to window-movement blocker 16. Biasing torque 34 urges window-movement blocker 16 to move in clockwise direction 56 about arm-rotation axis 22 from the window-unlocking position to the window-locking position. Window-movement blocker 16 moves in response to biasing torque 34 upon movement of barrier lock 30 from the locked position to the unlocked position as suggested in FIGS. 5-7. Illustratively, blocker mover 66 is a blocker-mover spring 68 that is configured to provide biasing torque 34 as shown in FIG. 4.

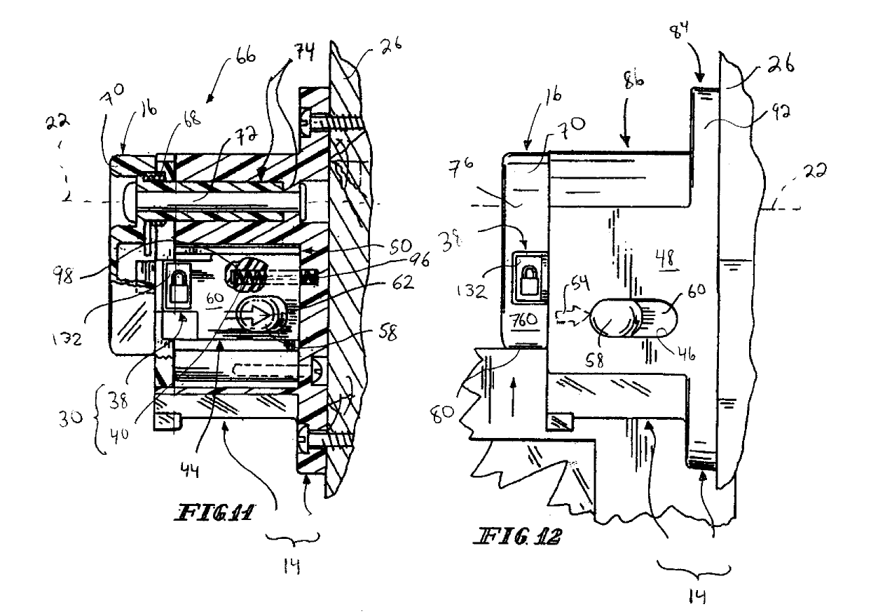

Window-movement blocker 16 includes a barrier arm 70 and an arm-rotation axle 72 that defines arm-rotation axis 22 as shown in FIGS. 4-12. Arm-rotation axle is arranged to extend toward blocker-support base 14 along arm-rotation axis 22 as shown in FIGS. 10 and 11. Arm-rotation axle 72 is arranged to lie in rotative bearing engagement with an axle receiver 74 formed in blocker-support base 14 so that barrier arm 70 may rotate about arm-rotation axis 22 without restraint.

As suggested in FIG. 4, axle receiver 74 includes an upper axle aperture 124 formed in blocker carrier 88 and a lower axle aperture 126 formed in carrier foundation 86. As suggested in FIG. 4, upper axle aperture 124 is formed to open into an actuator space 90 formed in blocker-support base 14 to permit arm-rotation axle 72 to extend through upper axle aperture 124 and lie in rotative bearing engagement with upper axle aperture 124. Lower axle aperture 126 is formed to open into actuator space 90 and configured to receive a distal end 130 of arm-rotation axle 72 as shown in FIGS. 10 and 11.

Barrier arm 70 includes, for example, a front wall 76, a rear wall 78, and a bottom wall 80 as shown in FIG. 4. Front wall 76 is coupled to arm-rotation axle 72 and positioned to lie in spaced-apart relation to arm-rotation axis 22. Rear wall 78 is coupled to arm-rotation axle 72 and positioned to lie in spaced-apart relation to front wall 76 to locate arm-rotation axle 72 therebetween. Bottom wall 80 is arranged to extend between front and rear walls 76, 78 and lie in spaced-apart relation to arm-rotation axle 72.

Bottom wall 80, front wall 76, rear wall 78, and arm-rotation axle 72 cooperate to define an anchor receiver 82 therebetween as shown in FIG. 4. Anchor receiver 82 is configured to receive anchor 38 therein upon movement of window-movement blocker 16 to the window-unlocking position and upon movement of barrier lock 30 to the locked position.

As suggested in FIG. 4, front wall 76 includes an inner surface 76I and an opposite outer surface 76O. Inner surface 761 is arranged to face toward rear wall 78 and outer surface 76O is arranged to face way from rear wall 78. Anchor 38 is positioned to lie in confronting relation with inner surface 76I upon movement of window-movement blocker 16 to the window-unlocking position and upon movement of anchor 38 to the locked position as shown in FIG. 5. Anchor 38 is positioned to lie in confronting relation with outer surface 76O upon movement of window-movement blocker 16 to the window-locking position and upon movement of barrier lock 30 to the locked position as shown in FIG. 7.

Illustratively, as shown in FIGS. 4, 9, and 12, lock-status indicia are included in lock 10 to visually communicate the status of lock 10 to a user. Lock-status indicia may be painted onto lock 10 or they may be separate tiles coupled to lock 10. As an example, lock-status indicia include a color-coded locked-status icon 132 and a color-coded unlocked-status icon 134. Color-coded locked-status icon 132 is illustratively green and has a closed lock which is visible when barrier arm 70 is in the window-locking position and barrier lock 72 is in the locked position as shown in FIGS. 2, 3, 9, and 12. Color-coded unlocked-status icon 134 is illustratively red and visible when barrier arm 70 is in the window-unlocking position and barrier lock 30 is in the locked position as shown in FIG. 1.

Window-movement blocker 16 is secured to window frame 26 by blocker-support base 14 as suggested in FIGS. 1-3. Blocker-support base 14 also provides support for blocker-movement controller 18 during use of lock 10 as suggested in FIGS. 5-8. As an example, blocker-support base 14 includes a foundation fastener 84, a carrier foundation 86, and a blocker carrier 88 as shown in FIG. 4. Foundation fastener 84 is adapted to mount to window frame 26 in a fixed position. Carrier foundation 86 is coupled to foundation fastener 84 and arranged to extend away from foundation fastener 84 toward window-movement blocker 16. Blocker carrier 88 is coupled to carrier foundation 86 and positioned to lie in spaced-apart relation to foundation fastener 84 to locate carrier foundation 86 therebetween.

As suggested in FIGS. 10 and 11, blocker carrier 88 and carrier foundation 86 cooperate to define actuator space 90 therebetween. Illustratively, lock mover 44 is positioned to lie within actuator space 90 and actuation slot 46 is configured to open into actuator space 90. Illustratively, anchor 38 is positioned to lie within actuator space 90 upon movement of barrier lock 30 to the un-locked position. Anchor 38 is arranged to extend out of actuator space 90 toward window-movement blocker 16 upon movement of barrier lock 30 to the locked position.

Carrier foundation, as shown in FIG. 4, includes front wall 48 and a rear wall 118 positioned to lie in spaced-apart relation to front wall 48. Illustratively, actuator space 90 is defined between front and rear walls 48, 118. Front wall 48 includes a locked-position stop 120 and an unlocked-position stop 122 positioned to lie in spaced-apart relation to locked-position stop 120 to cause actuation slot 46 to be formed therebetween. When barrier lock 30 is in the locked position, lock-mover button 58 of lock mover 44 is positioned to lie in confronting relation with locked-position stop 120. When barrier lock 30 is in the unlocked position, lock-mover button 58 is positioned to lie in confronting relation with unlocked-position stop 122.

Foundation fastener 84 illustratively includes a fastener plate 92 and a pair of fasteners 92a, 92b. As suggested in FIG. 4, fasteners 92a, 92b are a pair of screws, but any other suitable alternative may be used. Fastener plate 92 is appended to carrier foundation 86 and may be formed as a monolithic component.

Lock 10 in accordance with the present disclosure comprises blocker-support base 14, window-movement blocker 16, and blocker-movement controller 18. Blocker-support base 14 is adapted to mount to window frame 26 in a fixed position. Illustratively, window-movement blocker 16 includes a barrier arm 70 and an arm-rotation axle 72 that defines arm-rotation axis 22. Arm-rotation axle 72 is arranged to interconnect barrier arm 70 and blocker-support base 14 so that barrier arm 70 may rotate about arm-rotation axis 22 between the window-locking position (FIGS. 2 and 3) and the window-unlocking position (FIG. 1).

Blocker-movement controller 18 illustratively includes barrier lock 30, barrier-lock actuator 32, and blocker mover 66. Barrier lock 30 is coupled to blocker-support base 14 to move from the unlocked position to the locked position. Barrier lock 30, when in the unlocked position, is positioned to lie in spaced-apart relation to barrier arm 70 to cause barrier arm 70 to rotate between the window-unlocking position and the window-locking position. Barrier lock 30, when in the locked position, is arranged to interconnect barrier arm 70 and blocker-support base 14 to block rotation of barrier arm 70 relative to blocker-support base 14. Barrier-lock actuator is coupled to blocker-support base 14 to move relative to blocker-support base 14 with barrier lock 30.

Blocker-movement controller 18 further includes blocker mover 66 that is configured to provide biasing torque 34 to barrier arm 70 to cause barrier arm 70 to move from the window-unlocking position to the window-locking position. As shown in FIG. 4, blocker mover 66 is, for example, blocker-mover spring 68. Blocker-mover spring 68 is mounted around arm-rotation axle 72.

As an example, barrier lock 30 includes anchor 38 and anchor mover 40. Anchor 38 is positioned to lie in actuator space 90 formed in blocker-support base 14 upon movement of barrier lock 30 to the unlocked position. Anchor 38 is arranged to extend into anchor receiver 82 formed in barrier arm 70 upon movement of barrier lock 30 to the locked position and upon movement of barrier arm 70 to the window-locking position.

As suggested in FIG. 4, anchor mover 40 is configured to apply a biasing force 94 to anchor 38 to move anchor 38 out of actuator space 90 and into anchor receiver 82 during movement of barrier lock 30 from the unlocked position to the locked position. Illustratively, anchor mover 40 includes a spring-mount post 96 and an anchor-extension spring 98. Spring-mount post 96 is coupled to blocker-support base 14 and arranged to extend toward barrier arm 70. Anchor-extension spring 98 is mounted around spring-mount post 96 and configured to provide biasing force 94 to anchor in biasing-force direction 100 parallel to arm-rotation axis 22 and opposite actuation direction 54.

Barrier-lock actuator 32 includes lock mover 44, position guide 42, and blocker mover 66. Lock mover 44 is coupled to anchor 38 to move therewith to cause anchor 38 to move from the locked position to the unlocked position in response to application of button-actuation force 62. Position guide 42 is coupled to blocker-support base 14 and is configured to support anchor 38 and lock mover 44 during movement of barrier lock 30 between the locked and unlocked positions.

Position guide 42 includes lock support 50 and blocker-rotation support 52. Lock support 50 is coupled to blocker carrier 88 and arranged to extend toward foundation fastener 84 away from barrier arm 70 to cause anchor 38 and lock mover 44 to be supported during back-and-forth movement of anchor 38 and lock mover 44 during movement of the barrier lock 30 between the locked and unlocked positions. Blocker-rotation support 52 is coupled to blocker carrier 88 and arranged to extend away from blocker carrier 88 into anchor receiver 82 formed in barrier arm 70 to cause rotation of barrier arm 70 to be limited between the window-locking position and the window-unlocking position.

As shown in FIG. 4, lock support 50 is formed to include an anchor-mover grove 102 and an anchor slot 104. Anchor-mover groove 102 is configured to receive anchor 38 therein. Anchor slot 104 is formed to open into actuator space 90 and configured to receive and guide anchor 38 during movement of barrier lock 30. As suggested in FIG. 4, anchor slot 104 is configured to open between anchor receiver 82 and actuator space 90.

Blocker-rotation support, as shown for example in FIG. 4, includes a clockwise-rotation stop wall 106 and a counter-clockwise-rotation stop wall 108. The counter-clockwise-rotation stop wall 108 is coupled to blocker carrier 88 and arranged to extend away from blocker carrier 88 toward barrier arm 70 and into anchor receiver 82 to stop rotation of barrier arm 70 in counter-clockwise direction 36 about arm-rotation axis 22 upon movement of barrier arm 70 to the window-locking position. The clockwise-rotation stop wall 106 is couple to blocker carrier 88 and arranged to extend away from blocker carrier 88 toward barrier arm 70 into anchor receiver 82 to stop rotation of barrier arm 70 in clockwise direction 56 about arm-rotation axis 22 upon movement of barrier arm 70 to the window-unlocking position. Clockwise-rotation stop wall 106 and counter-clockwise-rotation stop wall 108 cooperate to define an acute angle 110 therebetween as shown in FIG. 4.

Illustratively, blocker-support base 14 includes foundation fastener 84, carrier foundation 86, and blocker carrier 88. Foundation fastener 84 is adapted to mount to window frame 26 in a fixed position. Carrier foundation 86 is coupled to foundation fastener 84 and arranged to extend away from foundation fastener 84 toward barrier arm 70. Blocker carrier 88 is coupled to carrier foundation 86 and is positioned to lie in spaced-apart relation to foundation fastener 84 to locate carrier foundation 86 therebetween. In addition, actuator space 90 is formed in blocker-support base 14 and defined between carrier foundation 86 and blocker carrier 88.

Lock 10 in accordance with present disclosure is used to block up-and-down movement of lower panel 24 included in window 12. Lock 10 illustratively includes blocker-support base 14, window-movement blocker 16, and blocker-movement controller 18. Blocker-support base 14 includes, for example, carrier foundation 86, foundation fastener 84, and blocker carrier 88. Carrier foundation 86 is adapted to lie in spaced-apart relation to window frame 26 in a fixed position. Foundation fastener 84 is coupled to carrier foundation 86 and adapted to mount carrier foundation 86 to window frame 26. Blocker carrier 88 is coupled to carrier foundation 86 and positioned to lie in spaced-apart relation to foundation fastener 84. Illustratively, foundation fastener 84, carrier foundation 86, and blocker carrier 88 cooperate to form actuator space 90 therebetween.

Window-movement blocker 16 includes barrier arm 70 and arm-rotation axle 72 that is coupled to barrier arm 70. Arm-rotation axle 72 is arranged to extend into actuator space 90 to define arm-rotation axis 22.

Barrier arm 70 is coupled to arm-rotation axle 72 and arranged to extend way from arm-rotation axle in perpendicular relation to arm-rotation axis 22. Barrier arm 70 is coupled to arm-rotation axle 72 to rotate about arm-rotation axis 22 between the window-unlocking position as shown in FIG. 1 and the window-locking position as shown in FIGS. 2 and 3.

When barrier arm 70 is in the window-unlocking position, barrier arm 70 is arranged to lie in a first generally vertical plane 112 as suggested in FIG. 1. Arm-rotation axis 22 is arranged to lie in coplanar relation with first generally vertical plane 112. When barrier arm 70 is in the window-locking position, barrier arm 70 is arranged to lie in a second angled plane 114. As suggested in FIG. 2, an acute plane angle 116 is defined between first generally vertical plane 112 and second angled plane 114.

Blocker-movement controller 18 illustratively includes barrier lock 30 and barrier-lock actuator 32. Barrier-lock actuator 32 is coupled to barrier lock 30 to move therewith. Barrier-lock actuator 32 is configured to transfer button-actuation force 62 to barrier lock 30 to overcome biasing force 94 and move barrier lock 30 from the locking position to the unlocking position. Barrier lock 30 includes anchor 38 and anchor mover 40 that is configured to provide biasing force 94 to barrier lock 30 to bias barrier lock 30 into the locking position.

When barrier lock 30 is in the locking position, anchor 38 is arranged to extend away from blocker carrier 88 toward barrier arm 70 to interconnect barrier arm 70 and blocker carrier 88 to cause barrier arm 70 to be blocked from moving relative to blocker-support base 14. When barrier lock 30 is in the unlocking position, anchor 38 is positioned to lie in spaced-apart relation to barrier arm 70 to cause barrier arm 70 to move relative to blocker-support base 14 between the window-unlocking position and the window-locking position.

1. A lock for a window, the lock comprising
a blocker-support base adapted to mount to a window frame in a fixed position,
a window-movement blocker mounted on the blocker-support base to move about an arm-rotation axis between a window-locking position wherein the window-movement blocker is adapted to block movement of a lower panel carried in a window frame to keep the lower panel in mating contact with a sill included in the window frame and a window-unlocking position wherein the window-movement blocker is adapted to allow movement of a lower panel carried in a window frame to move out of mating contact with a sill included in the window frame, and
a blocker-movement controller including a barrier lock including an anchor and an anchor mover and a barrier-lock actuator configured to provide means for moving the barrier lock in a first stage of movement from a locked position wherein the barrier lock is arranged to engage the window-movement blocker to cause movement of the window-movement blocker relative to the blocker-support base to be blocked to an unlocked position wherein the barrier lock is positioned to lie in spaced-apart relation to the window-movement blocker to free the window-movement blocker to move relative to the blocker-support base so that window-movement blocker is free to move in a second stage of movement in response to a biasing torque applied in a counter-clockwise direction about the arm-rotation axis to the window-movement blocker so that the window-movement blocker moves in a counter-clockwise direction about the arm-rotation axis relative to the blocker-support base from the window-locking position to the window-unlocking position.

2. The lock of claim 1, wherein the barrier-lock actuator includes a position guide coupled to the blocker-support base in a fixed position and a lock mover coupled to the anchor to move therewith and arranged to extend away from the blocker-support base through an actuation slot formed in a front wall of the blocker-support base.

3. The lock of claim 2, wherein the position guide includes a lock support coupled to the blocker-support base and arranged to extend away from the window-movement blocker in a direction parallel to the arm-rotation axis and a blocker-rotation support coupled to the blocker-support base and arranged to extend away from the blocker-support base toward the window-movement blocker to engage the window-movement blocker to limit rotation of the window-movement blocker about the arm-rotation axis in the clockwise direction to cause the window-movement blocker to assume the window-locking position and to limit rotation of the window-movement blocker about the arm-rotation axis in the counter-clockwise direction to cause the window-movement blocker to assume the window-unlocking position.

4. The lock of claim 2, wherein the lock mover includes a lock-mover button and a button-support plate, the button-support plate is arranged to lie between the front wall of the blocker-support base and the position guide, and the lock-mover button is coupled to the button-support plate to cause the button-support plate to move from the locked position to the unlocked position in response to application of a button-actuation force in a button-actuation direction away from the window-movement blocker and parallel to the arm-rotation axis.

5. The lock of claim 1, wherein blocker-movement controller further includes a blocker mover configured to provide means for providing a biasing torque to the window-movement blocker to bias the window-movement blocker to move in a clockwise direction about the arm-rotation axis from the window-unlocking position toward the window-blocking position in response to the barrier lock moving from the locked position to the unlocked position.

6. The lock of claim 5, wherein the blocker mover is a blocker-mover spring configured to provide the biasing torque to the window-movement blocker to bias the window-movement blocker into the window-locking position.

7. The lock of claim 1, wherein the window-movement blocker includes a barrier arm and an arm-rotation axle coupled to the barrier arm, the arm-rotation axle defines the arm-rotation axis and is arranged to extend toward the blocker-support base along the arm-rotation axle to lie in rotative bearing engagement with an axle receiver formed in the blocker-support base.

8. The lock of claim 7, wherein the barrier arm includes a front wall coupled to the arm-rotation axle and positioned to lie in spaced-apart relation to the arm-rotation axis, a rear wall coupled to the arm-rotation axle and positioned to lie in spaced-apart relation to the front wall to locate the arm-rotation axle therebetween, and a bottom wall arranged to extend between the front and rear walls and lie in spaced-apart relation to the arm-rotation axle.

9. The lock of claim 8, wherein the bottom wall, the front wall, the rear wall, and the arm-rotation axle cooperate to define an anchor receiver therebetween and the anchor receiver is configured to receive the anchor therein upon movement of the window-movement blocker to the window-unlocking position and upon movement of the barrier lock to the locked position.

10. The lock of claim 8, wherein the front wall includes an inner surface arranged to face toward the rear wall and an opposite outer surface arranged to face away from the rear wall, the anchor is arranged to lie in confronting relation with the inner surface upon movement of the window-movement blocker to the window-unlocking position and upon movement of the barrier lock to the locked position and the anchor is arranged to lie in confronting relation with the outer surface upon movement of the window-movement blocker to the window-locking position and upon movement of the barrier lock to the locked position.

11. The lock of claim 1, wherein the blocker-support base includes a foundation fastener adapted to mount to a window frame in a fixed position, a carrier foundation coupled to the foundation fastener and arranged to extend away from the foundation fastener toward the window-movement blocker, and a blocker carrier coupled to the carrier foundation and positioned to lie in spaced-apart relation to the foundation fastener to locate the carrier foundation between the blocker carrier and the foundation fastener.

12. The lock of claim 11, wherein the blocker carrier and the carrier foundation cooperate to define an actuator space therebetween, the lock mover is arranged to lie within the actuator space, the anchor is positioned to lie within the actuator space upon movement of the barrier lock to the un-locked position, and the anchor is arranged to extend out of the actuator space toward the window-movement blocker upon movement of the barrier lock to the locked position.

13. A lock for a window, the lock comprising
a blocker-support base being adapted to mount to a window frame in a fixed position,
a window-movement blocker including a barrier arm and an arm-rotation axle, the arm-rotation axle defining an arm-rotation axis, and the arm-rotation axle is arranged to interconnect the barrier arm and the blocker-support base to cause the barrier arm to rotate about the arm-rotation axle relative to the blocker-support base between a window-locking position and a window-unlocking position, and
a blocker-movement controller including a barrier lock coupled to the blocker-support base and configured to move from an unlocked position wherein the barrier lock is positioned to lie in spaced-apart relation to the barrier arm to cause the barrier arm to rotate between the window-unlocking position and the window-locking position toward a locked position wherein the barrier lock is arranged to interconnect the barrier arm and the blocker-support base to block rotation of the barrier arm relative to the blocker-support base and a barrier-lock actuator coupled to the blocker-support base to move relative to the blocker-support base with the barrier lock.

14. The lock of claim 13, wherein the barrier lock includes an anchor positioned to lie in an actuator space formed in the blocker-support base upon movement of the barrier lock to the unlocked position, the anchor is arranged to extend into an anchor receiver formed in the barrier arm upon movement of the barrier lock to the locked position and upon movement of barrier arm to the window-locking position, and an anchor mover configured to apply a biasing force to the anchor to move the anchor out of the anchor space and into the anchor receiver during movement of the barrier lock from the unlocked position to the locked position.

15. The lock of claim 14, wherein the anchor mover includes a spring-mount post coupled to the blocker-support base and arranged to extend toward the barrier arm and an anchor-extension spring mounted around the spring-mount post and configured to provide the biasing force to the anchor in a biasing-force direction parallel to the arm-rotation axis toward the barrier arm to bias the anchor into the locked position.

16. The lock of claim 13, wherein the blocker-movement controller further includes a blocker mover configured to provide a biasing torque to the barrier arm to cause the barrier arm to move from the window-unlocking position toward the window-locking position to allow the anchor to move from the unlocked positioned to the locked position.

17. The lock of claim 13, wherein the barrier-lock actuator includes a lock mover coupled to the anchor to move therewith to cause the anchor to move in response to application of button-actuation force from the locked position to the unlocked position and a position guide coupled to the blocker support base and configured to support the anchor and the lock mover during movement of the barrier lock between the locked position and the unlocked position.

18. The lock of claim 17, wherein the blocker-support base includes a foundation fastener adapted to mount to a window frame in a fixed position, a carrier foundation coupled to the foundation fastener and arranged to extend away from the foundation fastener toward the barrier arm, and a blocker carrier coupled to the carrier foundation and positioned to lie in spaced-apart relation to the foundation fastener to locate the carrier foundation between the blocker carrier and the foundation fastener, the blocker carrier and the carrier foundation cooperate to define an actuator space therebetween.

19. The lock of claim 18, wherein the position guide includes a lock support coupled to the blocker carrier and arranged to extend toward the foundation fastener away from the barrier arm to cause the anchor and the lock mover to be supported during back-and-forth movement of the anchor and the lock mover during movement of the barrier lock between the locked and unlocked positions and a blocker-rotation support coupled to the blocker carrier and arranged to extend away from the blocker carrier and into an anchor receiver formed in the barrier arm to cause rotation of the barrier arm to be limited between the window-locking position and the window-unlocking position.

20. The lock of claim 19, wherein the lock support is formed to include an anchor-mover groove configured to receive the anchor mover therein and an anchor slot opening into the actuator space and configured to receive and guide the anchor during movement of the barrier lock.

21. The lock of claim 19, wherein the blocker-rotation support includes a clockwise-rotation stop wall and a counter-clockwise-rotation stop wall, the counter-clockwise-rotation stop wall is coupled to the blocker carrier and arranged to extend away from the blocker carrier toward the barrier arm and into the anchor receiver to stop rotation of the barrier arm in the counter-clockwise direction about the arm-rotation axis upon movement of the barrier arm to the window-locking position, the clockwise-rotation stop wall is coupled to the blocker carrier and arranged to extend away from the blocker carrier toward the barrier arm and into the anchor receiver to stop rotation of the barrier arm in the clockwise direction about arm-rotation axis upon movement of the barrier arm to the window-unlocking position, and the clockwise-rotation stop wall and the counter-clockwise rotation stop wall cooperate to define an acute angle therebetween.

22. A lock for a window, the lock comprising
a blocker-support base including a carrier foundation adapted to lie in spaced-apart relation to a window frame in a fixed position, a foundation fastener coupled to the carrier foundation and adapted to mount the carrier foundation to a window frame, and a blocker carrier coupled to the carrier foundation and positioned to lie in spaced-apart relation to the foundation fastener, and the foundation fastener, carrier foundation, and blocker carrier cooperate to form an actuator space therebetween,
a window-movement blocker including a barrier arm and an arm-rotation axle coupled to the barrier arm and arranged to extend into the actuator space to define an arm-rotation axis, the barrier arm is coupled to the arm-rotation axle and arranged to extend away from the arm-rotation axle in perpendicular relation to the arm-rotation axis, and the barrier arm is coupled to the arm-rotation axle to rotate about the arm-rotation axis between a window-unlocking position wherein the barrier arm is arranged to lie in a first generally vertical plane wherein the arm-rotation axis is arranged to lie in coplanar relation with the first generally vertical plane and a window-locking position wherein the barrier arm is arranged to lie in a second angled plane to cause an acute plane angle to be defined between the first generally vertical plane and the second angled plane, and
a blocker-movement controller including a barrier lock including an anchor mover configured to provide a biasing force to the barrier lock to bias the barrier lock into a locking position and an anchor coupled to the anchor mover to move therewith, the barrier lock is configured to move between the locking position wherein the anchor is arranged to extend away from the blocker carrier toward the barrier arm to interconnect the barrier arm and the blocker carrier to cause the barrier arm to be blocked from moving relative to the blocker-support base and an unlocking position wherein the anchor is positioned to lie in spaced-apart relation to the barrier arm to cause the barrier arm to move relative to the blocker-support base between the window-locking position and the window-unlocking position, and a barrier-lock actuator coupled to the barrier lock to transfer a button-actuation force to the barrier lock to overcome the biasing force and move the barrier lock from the locking position to the unlocking position.
